(19) United States
(12) Patent Application Publication
(10) Pub. No.: US 2014/0149487 A1
(43) Pub. Date: May 29, 2014

(54) REPLICATION AND DECODING OF AN INSTANT MESSAGE DATA THROUGH A PROXY SERVER

(71) Applicants: Cemal Dikmen, Trumbull, CT (US); Bulent Erbilgin, Cupertino, CA (US); Mohammed Abdul-Razzak, Union City, CA (US)

(72) Inventors: Cemal Dikmen, Trumbull, CT (US); Bulent Erbilgin, Cupertino, CA (US); Mohammed Abdul-Razzak, Union City, CA (US)

(21) Appl. No.: 13/684,244

(22) Filed: Nov. 23, 2012

(51) Int. Cl. G06F 15/16

(52) U.S. Cl. CPC G06F 15/16
USPC 709/203

(57) ABSTRACT

A method and system related to a replication and decoding of an online message data between a person of interest (POI) and a correspondent of the POI through a proxy server. According to one embodiment, a method of communication capture includes collecting, at a system server, and processing at a service platform, a content data associated with an online text, audio, or video conversation between a POI and a correspondent of the POI, and replaying the content data through a combination of a client application emulator and a proxy server to generate a realistic representation of the content data. In addition, the method may include identifying a client application based on a metadata associated with the online chat conversation.

### FIELD OF TECHNOLOGY

This disclosure relates to a method and a system of generating and analyzing a realistic representation of a chat conversation between a person of interested (POI) and a correspondent of the POI to be used by a law enforcement agent.

### BACKGROUND

Law enforcement agencies may need to monitor a network communication of a person of interest. A timely access and monitoring of a network communication may be vital to national security. The large volume of daily network traffic may make it difficult to pinpoint a communication of a criminal nature. For example, the Internet has become a forum for terrorist groups to communicate with one another, but oftentimes such activity goes unnoticed. In addition, a communication of a criminal nature may be in a foreign language, which may make it even more difficult for law enforcement agencies to discover and act upon such information in a timely manner. In addition to a text communication, audio/video calls may also be transferred to and from a person of interest containing information of interest to law enforcement agencies. Such media content may be difficult to capture and access, which may deprive law enforcement agencies of important leads. The inability to obtain network communication of a criminal nature as it transpires between persons of interest may mean delayed investigation by law enforcement agencies and prolonged endangerment of lives and property.

### SUMMARY

Disclosed are a method and a system to process and replay an online chat/IM message data between a person of interest (POI) and a correspondent of the POI to be used by a law enforcement agent.

In one aspect, a method includes collecting, at a system server, and processing at a service platform, a content data associated with an online chat conversation between a POI and a correspondent of the POI and replaying the content data through a combination of a client application emulator and a proxy server to generate a realistic representation of the content data. The method may further include identifying a client application based on a metadata associated with the online chat conversation, selecting the client application emulator from a set of client application emulators to correspond to the client application, and selecting the proxy server from a set of proxy servers to correspond to the client application emulator.

The method may also involve operating the combination of a client application emulator and a proxy server on a virtual machine and/or a physical machine and capturing the realistic representation of the content data by recording from a sound driver and/or a video driver on the virtual machine and/or the physical machine. The method may present the realistic representation of the content data at a workstation associated with an analyst and store the realistic representation of the content data in a data store associated with the system server. In addition, the method may replicate the content data in real-time such that the realistic representation of the content data is generated contemporaneously with the online chat conversation. The replicating of the content data in real-time may be scheduled through a queue server associated with the media-processing module of the service platform, and the realistic representation of the content data may be streamed to a workstation associated with an analyst.

The method may further include screening the online chat conversation based on a set of predetermined screening criteria comprising a correspondent of the POI, a time of the online chat conversation, a date of the online chat conversation, an attachment type associated with the online chat conversation, a duration of the online chat conversation, a waveform associated with the online chat conversation, and/or a keyword contained in a transcription of the online chat conversation. A priority level of the chat conversation may be generated based on the set of predetermined screening criteria, and the set of the online chat conversations may be organized based on the priority level of the chat conversations. In addition, the set of the online chat conversations may be organized based on the set of predetermined screening criteria and a special alert may be generated when the priority level of the chat conversation is greater than a predetermined threshold. The method may additionally include duplicating, in real-time and transmitting, to a workstation, a voice attachment, a data attachment and/or a video attachment when the voice attachment, the data attachment and/or the video attachment is transmitted through the online chat conversation between the POI and the correspondent of the POI.

In another aspect, a method includes capturing an online chat conversation between a POI and a correspondent of the POI, simultaneously storing a content data comprising information related to the online chat conversation in a data store, and replicating the content data on a client application emulator communicatively coupled with a proxy server that emulates a server through which the online chat conversation is established. A realistic representation of the content data is captured and stored in a data store.

The method may also include creating a transcript of the online chat conversation, automatically creating a folder associated with the POI and any associate of the POI, and organizing a set of online chat conversations associated with the POI through a time of the online chat conversation, a priority level of the online chat conversation, and/or a key word in the transcript of the online chat conversation. The method may further include creating a transcript of the online chat conversation, determining that a particular communication is in a foreign language, and automatically translating the communication after consulting a translation database.

In yet another aspect, a system comprises a processor communicatively coupled with a volatile memory and a non-volatile storage having a media processing module that includes a proxy server to emulate a server associated with a client application, a client application emulator to generate an audible and/or a viewable version of an online chat conversation, and a media capture module to capture an audible and/or a viewable version of the online chat conversation. A storage module communicatively coupled to the media processing module stores an audible and/or a viewable version of the online chat conversation.

The system may also include a system server to collect a set of communication and transaction data from a network being used by the POI, to process the set of communication and transaction data, to extract a metadata and a content data of the set of communication and transaction data, and to store the metadata and the content data. The system may further include a communication channel, to automatically transmit the metadata and the content data between modules of the service platform and the system server. The system may further comprise a service platform to receive and store the metadata and the content data, to transmit the metadata and the content data to the media processing module and to receive the audible and/or the viewable version of the content data from the media processing module. Furthermore, the system may include a screening module screen the online chat conversation for a set of predetermined screening criteria, to organize the set of the online chat conversations based on the set of predetermined screening criteria, to generate a priority level of the online chat conversation based on the set of predetermined criteria, and to generate a special alert when the priority level of the online chat conversation is greater than a predetermined threshold level.

The methods and systems disclosed herein may be implemented in any means for achieving various aspects. Other features will be apparent from the accompanying drawings and from the detailed description that follows.

### BRIEF DESCRIPTION OF THE DRAWINGS

FIG. 1 illustrates a system architecture 100 showing a content data 104 that is captured from an online chat conversation 102 a person of interest (POI) 130 and a correspondent of the person of interest 124 to be replayed through a combination of a client application emulator 190 and a proxy server 192 to generate a realistic representation of content data 105 and present it to an analyst 110 at a workstation 118, according to one embodiment.

FIG. 2 illustrates a system overview 200 showing a service platform 164 that process the content data 104 transmitted from system servers 160A-160N through a communication channel 162, according to one embodiment.

FIG. 3 illustrates a closer view of the system server 160 comprising of a collection interface module 320, a data processing engine 322 and a storage module 324, according to one embodiment.

FIG. 4 illustrates a media processing 400 at the service platform 164 comprising of a media processing module 172, an analysis module 408, a translation module 196, a screening module 170 and a notification module 174, according to one embodiment.

FIG. 5 illustrates a closer view of the media processing module 172 comprising of a combination of client application emulators 190A-190N and proxy servers 192A-192N connected to a media capture module 504A-504N, according to one embodiment.

FIG. 6 illustrates a schematic view of how the content data 104 can be processed to generate a transcript 600 of the realistic representation of the content data 105 to be stored in a folder 602 associated with the POI 130 to be prioritized by the screening module 170 in order to generate an alert 614 through an alert generator module 606, according to one embodiment.

FIG. 7 illustrates a process flow of capturing the online chat conversation 102 and generating the realistic representation of content data 105, according to one embodiment.

FIG. 8 illustrates a table view of a set of online chat conversations 604 associated with the POI 130 and a set of screening criteria 802 that determine a priority level 816, according to one embodiment.

### DETAILED DESCRIPTION

Example embodiments, as described below, may be used to provide a method and/or a system of replicating and decoding an online message data between a POI and a correspondent of the POI through a proxy server. Although the present embodiments have been described with reference to specific example embodiments, it will be evident that various modifications and changes may be made to these embodiments without departing from the broader spirit and scope of the various embodiments.

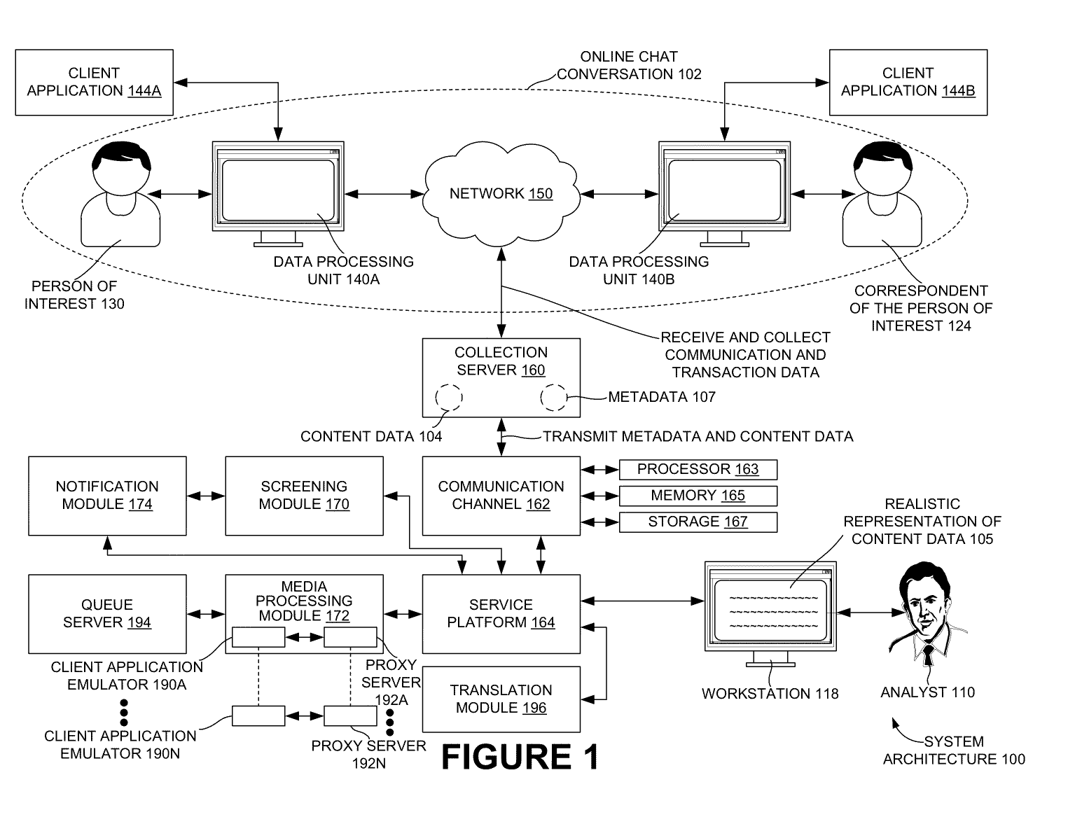

FIG. 1 illustrates a system architecture 100 comprised of a POI 130, a correspondent of the POI 124, a data processing unit 140A and 140B, a network 150, a system server 160 containing a content data 104 and a metadata 107, a communication channel 162, a service platform 164, a notification module 174, a screening module 170, a media processing module 172 comprised of a client application emulator 190 and a proxy server 192, a queue server 194, a translation module 196, a workstation 118 displaying a realistic representation of content data 105 to an analyst 110. FIG. 1 traces the content data 104 that is captured from the online chat conversation 102 between the person of interest (POI) 130 and the correspondent of the person of interest 124 to be replayed through the combination of the client application emulator 190 and the proxy server 192 to generate the realistic representation of content data 105 and present it to the analyst 110 at the workstation 118, according to one embodiment.

In one or more embodiments, the analyst 110 may be an analyst at a law enforcement agency, or a management consultancy and may want to collect, consolidate, analyze and visualize a set of raw data acquired through legal means. In one or more embodiments, the analyst 110 may be a part of an intelligence agency, a police force, a law enforcement consulting company and/or management company. In one or more embodiments, the analyst 110 may be part of an investigation. The investigation may be a criminal investigation, a civil investigation, in investigation of an employee violating a corporate regulation/conduct, investigation to ascertain compliance with laws and regulations as well as creating reports verifying such compliance, an investigation to save money and/or resource for a company or any other investigation.

In one embodiment, a method includes collecting, at the system server 160, and processing at the service platform 164, the content data 104 associated with the online chat conversation 102 between the POI 130 and the correspondent of the POI 124 and replaying the content data 104 through a combination of the client application emulator 190 and the proxy server 192 to generate the realistic representation of the content data 105. The method may present the realistic representation of the content data 105 at a workstation 118 associated with an analyst 110. The method may further include identifying the client application 144 based on the metadata 107 associated with the online chat conversation 102. In one or more embodiments, the system server 130 may be able to collect the set of communication and transaction data from the data processing unit 140A associated with the POI 130 form the network 150.

In addition, the method may replicate the content data 104 in real-time such that the realistic representation of the content data is generated contemporaneously with the online chat conversation 102. The replicating of the content data 104 in real-time may be scheduled through the queue server 194 associated with the media-processing module 172 of the service platform 164, and the realistic representation of the content data 105 may be streamed to the workstation 118 associated with the analyst 110.

In one or more embodiments, the system server 160 may process a set of communication and transaction data to extract the metadata 107 and the content data 104. The metadata 107 may be an information about the data in one or more embodiments. The metadata 107 may encompass a set of information related to the senders and receivers of the information, a time of a communication event, or where an information was collected from. In one or more embodiments, the metadata 107 may also be a cyber-name, a cyber-address, contact list, an analyst login information, a chat IP address, a chat alias, a VOIP address, a web forum login, a website login, a social network login, a sender and/or receiver of a chat, a time of a chat conversation, a file name sent in a chat or an email or any other cyber-communication, a number of files transferred in the cyber communication, a type of chat text, a name of an audio and/or video attachment sent in the cyber communication, a number of parties involved in a communication, a buddy list, an avatar description associated with the cyber communication. The metadata 107 may also be associated with voice and/or voice over IP communications. The metadata 107 may also be associated with social networking sites, a time of a social networking communication, a size of a social networking communication, a number of followers and others. The metadata 107 may also include telephone numbers, IMSI information and/or IMEI information.

The content data 104 may consist of the actual text of the communication, attachments in the communication and what the information actually says. The content data 104 may include the substantive portion of a record. In addition to the text of the communication, or a transcript of a recorded conversation, it may also include a text of an attachment, a transfer file, a content of an uploaded or downloaded document/video or any other file, a pooled information between many users, a substance of social network communication, a message exchanged between two parties, and any other communication.

In one or more embodiments, the communication channel 162 may automatically transmit the metadata 107 and the content data 104 between modules of the service platform 164 and the system server 160. In one or more embodiments, the communication channel 162 comprises a processor 163 communicatively coupled with a volatile memory 165 and a non-volatile storage 167. In one or more embodiments, the online chat conversation 102 may occur through any chat vehicle. For example, the chat vehicle may be AIM®, Google® chat, Yahoo® chat messenger or any other chat messenger or chatting system.

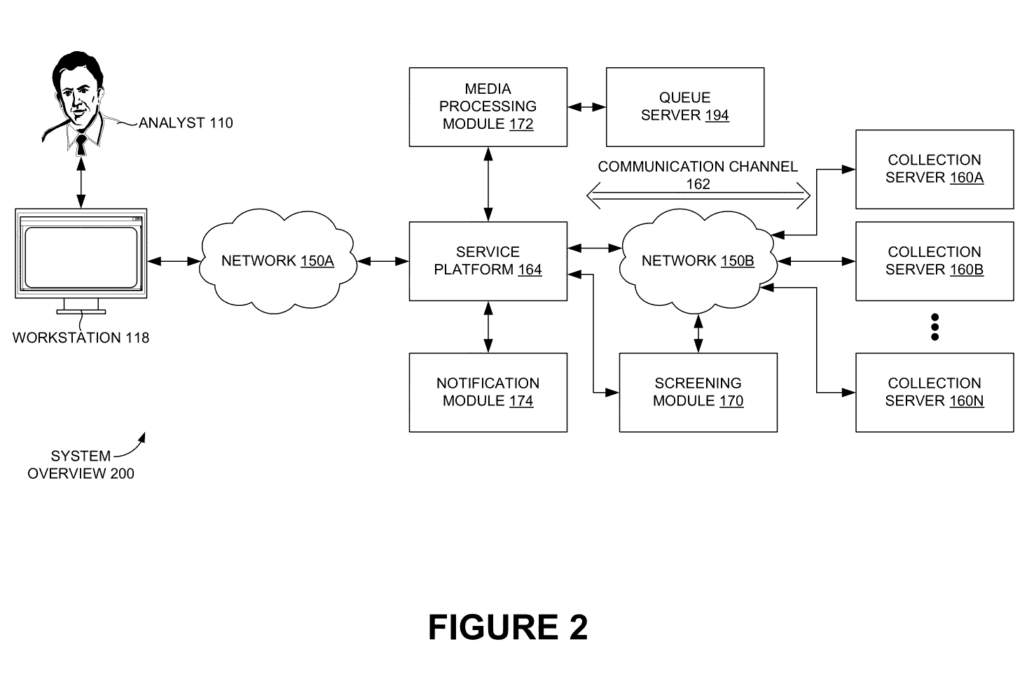

FIG. 2 illustrates a system overview 200 showing the system servers 160A-N, a network 150B, the communication channel 152, the queue server 194, the media processing module 172, the service platform 164, the notification module 174, a network 150A, the workstation 118 and the analyst 110. The service platform 164 processes the content data 104 transmitted from the system servers 160A-160N through the communication channel 162, according to one embodiment. In one or more embodiments, the service platform 164, the system server 160 and the communication channel 162 may all be able to communicate with each other through the network 150B. In one or more embodiments, the workstation 118 being used by the analyst 110 may be connected to the service platform 162 through the network 150A, and the communication channel 162 may span another network, network 150B, to connect the system servers 160A-N with the service platform 164. In one or more embodiments, the various modules, including the media processing module 172, the notification module 172, and the screening module 170 may all be able to communicate through the network 150B as well.

In one or more embodiments, the set of system servers 160A-160N spread through a region with an ability to connect to the network 150B to receive the set of communication and transaction data of interest from the network 150B. In one or more embodiments, the communication channel 162 may be a mode of electronic transportation linking the set of system servers 160A-N sprawled across the network 150B.

The system server 160 may be any brand of server and any type of server computer, blade server or any other processing device capable to performing the data management and communication functions with any quantity of cores, e.g. a six (6) core X86 Intel Quad Xeon MP, which may be programmed for any type of operating system (“OS”), e.g., Solaris UNIX, LINUX, or other server computing OS. In one or more embodiments, the system may be run on an Intel86 based processor using Linux RHEL with 64 bit OS. The system may be run on a direct or NAS storage device or appliance. The system is not limited to Intel x86, Linux RHEL, Direct/NAS storages and can be implemented on any computer hardware, OS and storage devices.

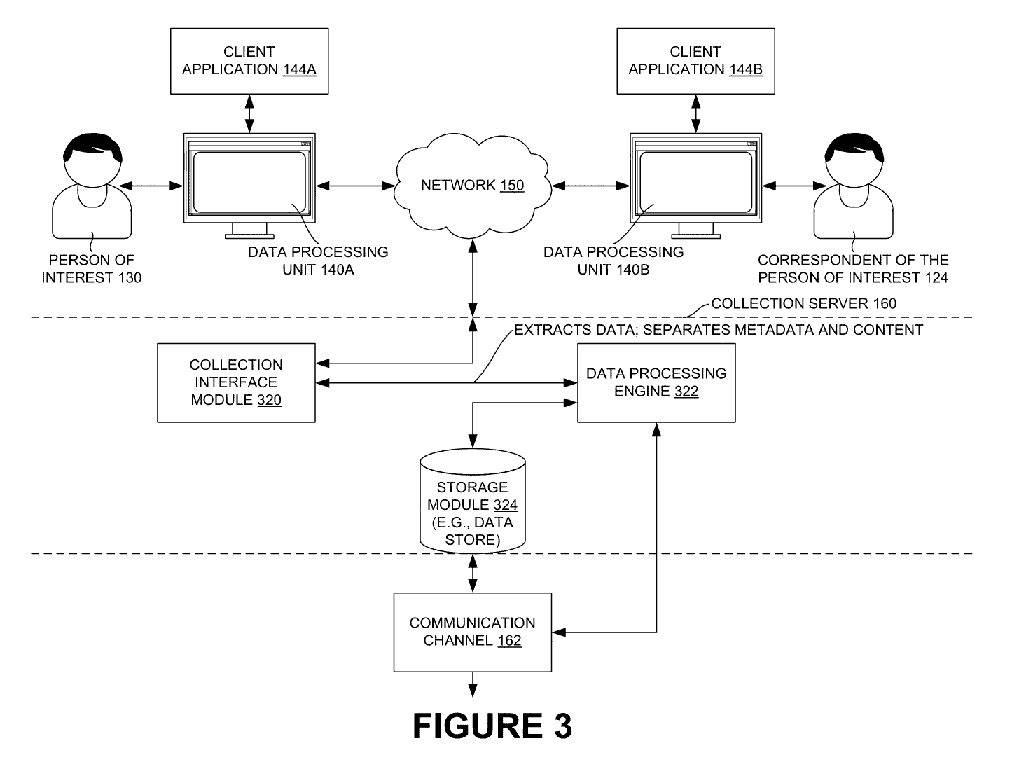

FIG. 3 illustrates a detailed view of the system server 160 comprising of a collection interface module 320, a data processing engine 322 and a storage module 324, according to one embodiment. In one or more embodiments, the system server 160 collects a set of communication and transaction data from the network 150 being used by the POI 130, to process the set of communication and transaction data, to extract the metadata 107 and the content data 104 from the set of communication and transaction data, and to store the metadata 107 and the content data 104.

The collection interface module 320 receives the legally collected content data 104. In one or more embodiments, the legally collected content data 104 may be a set of communication and transaction data between the person of interest (POI) 130 and the correspondents of the POI 124. In one or more embodiments, the POI 130 may be a suspect in a criminal investigation, a lead in a criminal investigation, or any person of interest in a criminal and/or civil investigation. The correspondent of the POI 124 may be an individual or an entity that may communicate by any means with the POI, in one or more embodiments.

In one or more embodiments, the collection interface module 320 may be linked to the data processing engine 322 that may sort and organize the set of communication and transaction data collected from the network 150. The data processing engine 322 may then process the set of communication and transaction data to extract the metadata 107 and the content data 104. In one or more embodiments, after processing the set of communication and transaction data, the content data 104 may be stored locally at the storage module 324 while the metadata 107 may be transmitted through the communication channel 162 to the service platform 164.

In one or more embodiments, the collection interface module 320 and the data processing engine 322 may process the set of communication and transaction data to extract the metadata 107 and the content data 104 of the set of the communication and transaction data. For example, the POI 130 may initiate the online chat conversation 102 with the correspondent of the POI 124. The collection interface module 320 may immediately collect the set of communication and transaction data associated with online chat conversation 102 between the POI 130 and the correspondent of the POI 124. In one or more embodiments, the data processing engine 322 may separate the contents of the online chat conversation 102 to generate the metadata 107 of the online chat conversation 102 and the content data 104 of the online chat conversation 102. For example, the metadata of the online chat conversation may be an identity of the correspondent of the POI, and a time and a date of the online chat conversation.

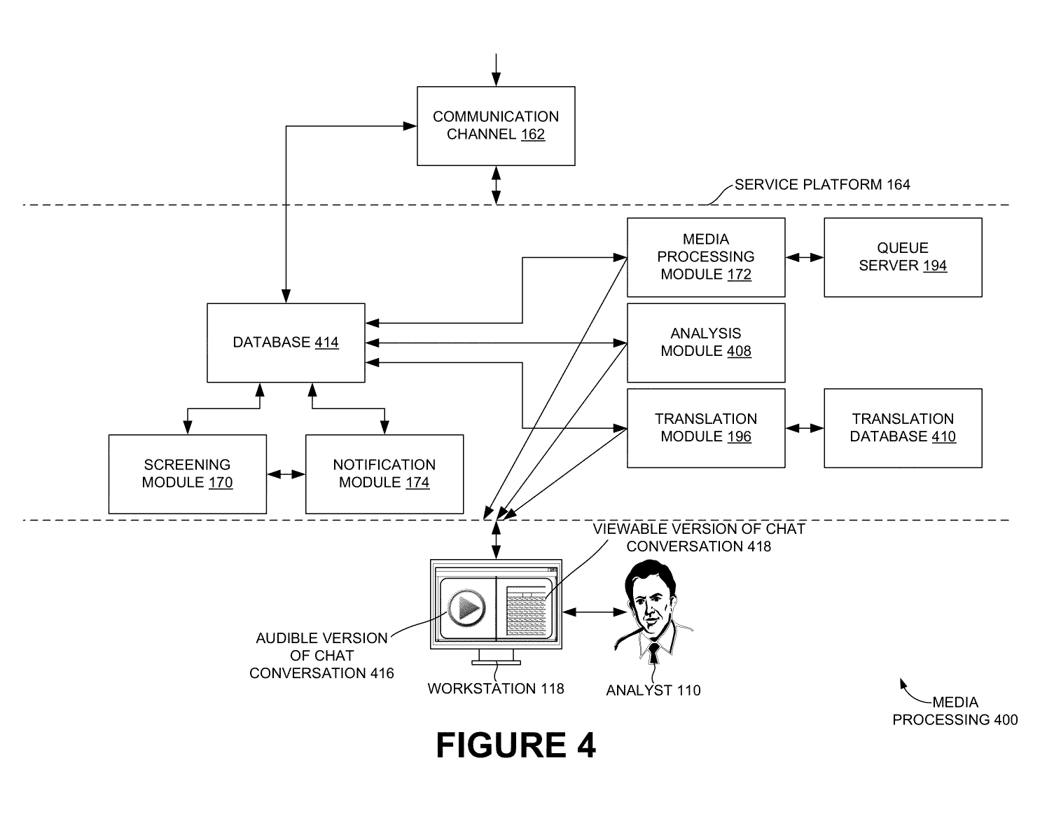

FIG. 4 illustrates a media processing 400 at the service platform 164 comprising of the media processing module 172, an analysis module 408, the translation module 196, a translation database 410, the queue server 194, the screening module 170, a database 414 and a notification module 174. According to one or more embodiments, the processed set of communication and transaction data is presentable in an audible version 416 and a viewable version 418 of the chat conversation on the workstation 118 to be viewed by the analyst 110.

According to one or more embodiments, the service platform 164 receives and stores the metadata 107 and the content data 104, to transmit the metadata 107 and the content data 104 to the media processing module 172 and to receive the audible 416 and/or the viewable 418 version of the content data 104 from the media processing module 172. Furthermore, the screening module 170 may screen the online chat conversation 102 for a set of predetermined screening criteria 802, according to one or more embodiments.

In one or more embodiments, the metadata 107 and any text content data 104 may be automatically transmitted to the database 414 in the service platform. In one or more embodiments, the storage module 170 may hold data records of the database 414. In one or more embodiments, the analyst 110 at the service platform 164 may then be able to immediately access the metadata 107 and text content data 104 to analyze and visualize the set of communication and transaction data. If the analyst does decide to view the content data 104, the analyst may request the information stored in the storage module 324 and the content data 104 may then be transmitted to the analyst 110 through the communication channel 162.

In one or more embodiments, the notification module 174 may process a particular metadata 107 communicated to the service platform 164 through the communication channel 162 and deduce that the particular metadata 107 is associated with an online chat conversation 102. Once the notification module 174 has deduced that an online chat conversation 102 is in session between the POI 130 and the correspondent of the POI 124, the notification module 174 may immediately alert the analyst 110 at the workstation 118 that an online chat conversation 102 has commenced between the POI 130 and the correspondent of the POI 124. In one or more embodiments, the notification module 174 may immediately generate an alert 614 to the analyst 110.

In one or more embodiments, after the notification module 174 has deduced that an online chat conversation 102 has commenced, the content data 104 of the online chat conversation 102 may immediately be transported through the communication channel 162 to the service platform 164 from the system server 160. In one or more embodiments, the content data 104 associated with the online chat conversation 102 may be further analyzed at the service platform 164.

In one or more embodiments, the screening module 170 may work in conjunction with the notification module 174. In one or more embodiments, the screening module 170 may automatically screen at least one of the content data 104 and the metadata 107 associated with the online chat conversation 102. In one or more embodiments, the screening module 170 may screen the content data 104 and/or metadata 107 based on a set of predetermined screening criteria 802 specified by the analyst 110.

In one or more embodiments, the media processing module 172 may produce a real-time duplicate transcript 600 of the online chat conversation 102 automatically and simultaneously as the online chat conversation 102 occurs between the POI 130 and the correspondent of the POI 124. In one or more embodiments, the media processing module 172 may produce the duplicate transcript 600 and store the duplicate transcript 600 in the database 414 at the service platform 164. In one or more embodiments, the queue server 194 schedules the generation of the duplicate transcript 600 in real-time through the media processing module 172. In one or more embodiments, the analyst 110 is able to view the duplicate transcript 600 in real-time to better analyze the communication between the POI 130 and the correspondent of the POI 124. In one or more embodiments, the replication of the content data 104 in real-time may generate the viewable version 418 and the audible version 416 of the chat conversation to be presented to the analyst 110 as the online chat conversation 102 is unfolding.

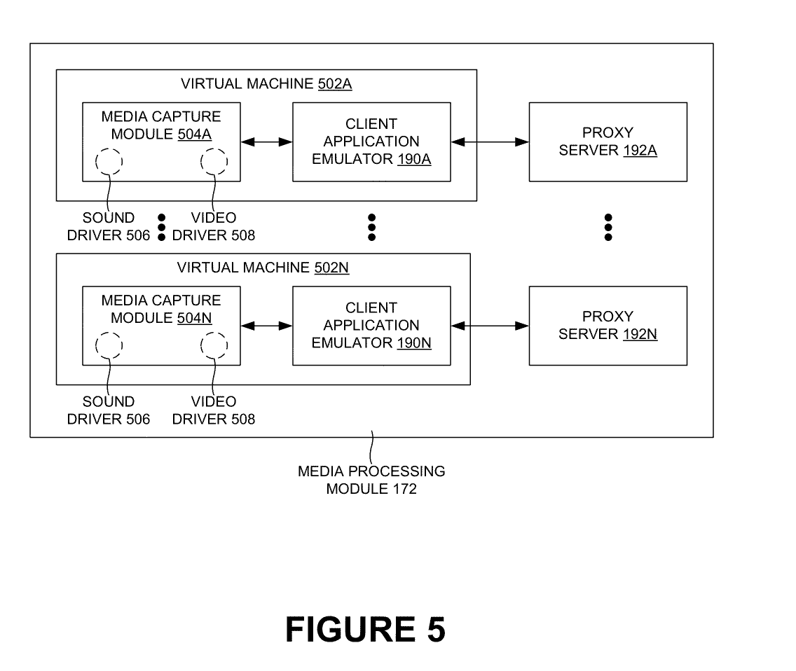

FIG. 5 illustrates a closer view of the media processing module 172 comprised of a combination of a set of proxy servers 192A-192N connected to a set of virtual machines 502A-N further comprising a set of client application emulators 190A-190N and a media capture module 504A-504N, according to one embodiment. The virtual machines 502A-N may also be physical machines. In one or more embodiments, the client application emulator 190 is selected from a set of client application emulators 190A-190N to correspond to the client application 144, and the proxy server 192 is selected from the set of proxy servers 192A-192N to correspond to the client application emulator 190. The combination of the client application emulator 190 and the proxy server 192 may be operated on the virtual machine 502 to capture the realistic representation of the content data 105 by recording from a sound driver 506 and/or a video driver 508 on the virtual machine 502.

In one or more embodiments, the media processing module 172 includes the proxy server 192 to emulate the server associated with the client application 144, the client application emulator 190 to generate the audible 416 and/or a viewable 418 version of the online chat conversation 102, and the media capture module 504 to capture the audible 416 and/or a viewable 418 version of the online chat conversation.

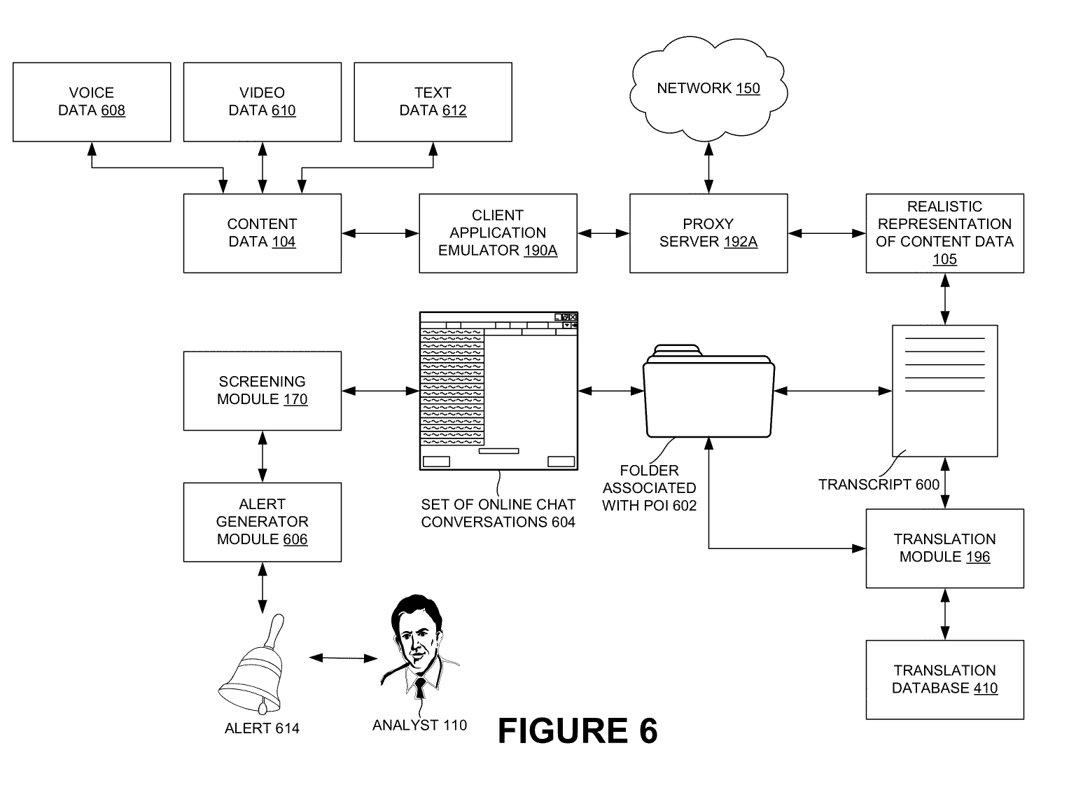

FIG. 6 illustrates the content data comprising of a voice data 608, a video data 610, and a text data 612, the client application emulator 190A in combination with the proxy server 192A connected to the network 150 to generate the realistic representation of content data 105, a transcript 600 of the content data 104, the translation module 196 connected to the translation database 196, a folder associated with the POI 602 containing a set of online chat conversations 604 to be screened by the screening module 170 in order to send an alert 614 to the analyst 110 through the alert generator module 606. In one or more embodiments, the media processing module 172 may produce a real-time duplicate transcript 600 of the online chat conversation 102 automatically and simultaneously as the online chat conversation 102 occurs between the POI 130 and the correspondent of the POI 124.

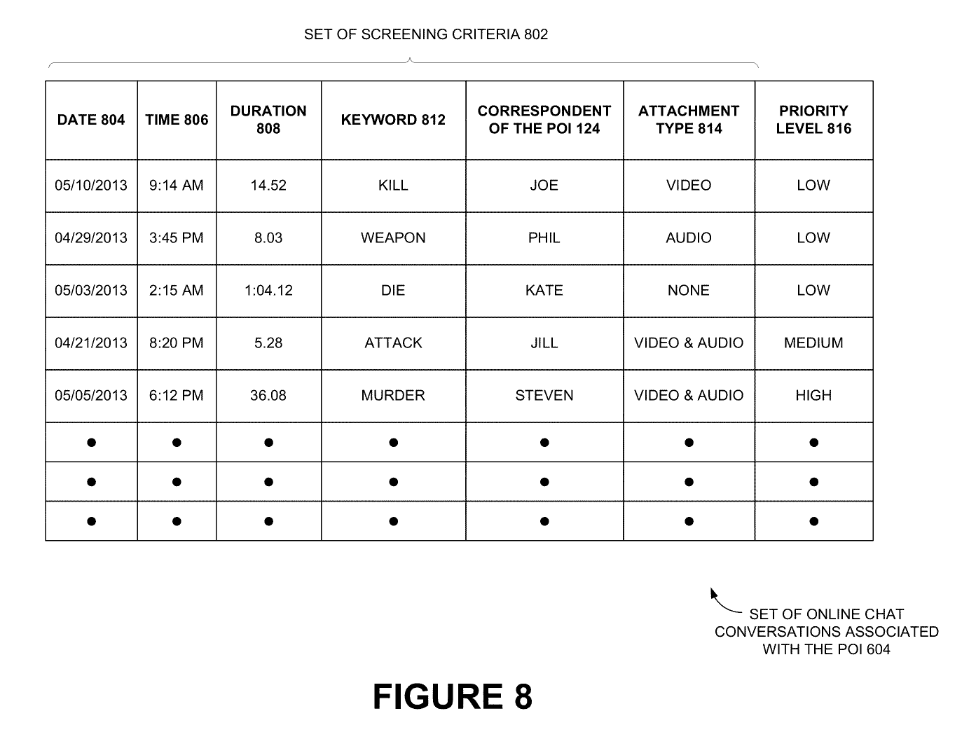

In one or more embodiments, the voice attachment 608, the data attachment 612 and/or the video attachment 610 may be duplicated, in real-time and transmitted when the voice attachment 608, the data attachment 612 and/or the video attachment 610 is transmitted through the online chat conversation 102 between the POI 130 and the correspondent of the POI 124. In addition, the set of the online chat conversations 604 may be organized based on the set of predetermined screening criteria 802 shown in FIG. 8, to generate a priority level 816 of the online chat conversation 102 based on the set of predetermined criteria 802 and a special alert may be generated when the priority level 816 of the chat conversation is greater than a predetermined threshold.

In one or more embodiments, when the priority level 816 is greater than a threshold level, the analyst 110 may receive a special alert 614 to notify the analyst 110 about an especially important online chat conversation 102. For example, when the priority level is “HIGH,” the analyst 110 may receive a special alert 614 to notify that this particular online chat conversation 102 is especially important. In one or more embodiments, the analyst 110 may be able to decide the importance and weight of various predetermined screening criteria 802 to help the screening module 170 screen and organize the set of online chat conversations 102 based on priority level 816.

In one or more embodiments, as soon as an online chat conversation 102 is initiated, the combination of the client application emulator 190A and the proxy server 192A may create a folder 602 associated with the POI 130 to contain the set of online chat conversations 604 associated with the POI 130. In one or more embodiments, the analyst may be able to view the set of online chat conversations 604 by selecting the folder 602 to view all chat conversations.

In one or more embodiments, upon the creation of the transcript 600 of the online chat conversation 102, the translation module 196 may determine that a particular communication is in a foreign language, and automatically translate the communication after consulting the translation database 410. The translation module 196, may immediately consult with a translation database 410 to translate, in real-time, the online chat conversation 102 between the POI 130 and the correspondent of the POI 124.

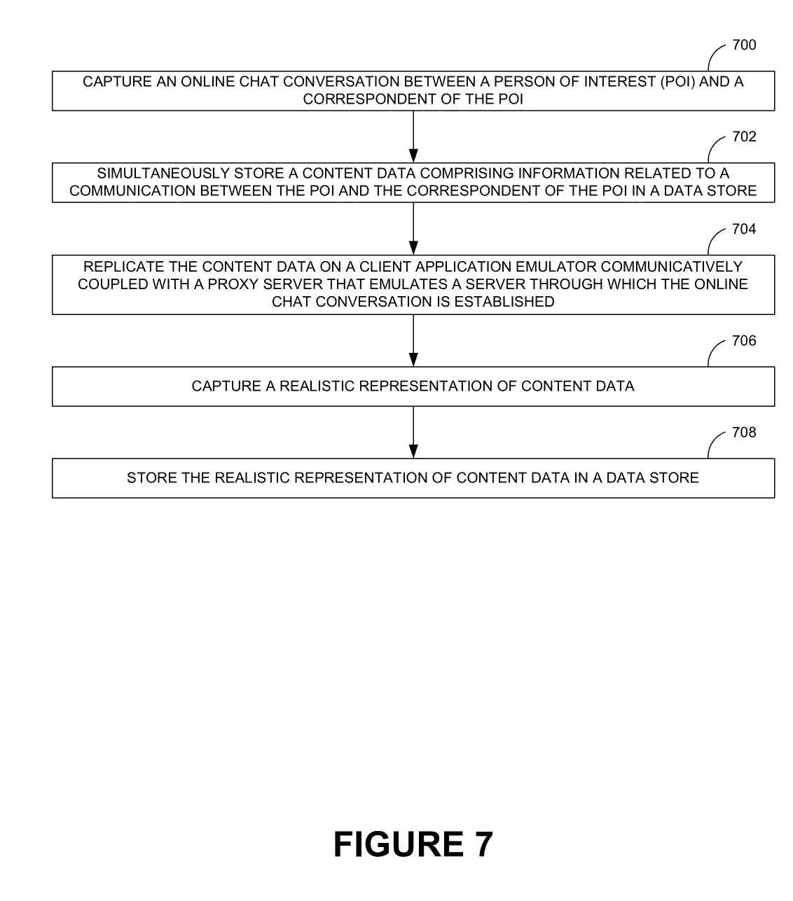

FIG. 7 illustrates a process flow of capturing an online chat conversation 102 between a POI 130 and a correspondent of the POI 124, according to operation 700. Operation 702 involves simultaneously storing a content data 104 comprising information related to the online chat conversation 102 in a data store 324. Operation 704 involves replicating the content data 104 on a client application emulator 190 communicatively coupled with a proxy server 192 that emulates a server through which the online chat conversation 102 is established. In operation 706, a realistic representation of the content data 105 is captured. The captured realistic representation of the content data 105 is stored in a data store 324, according to operation 708.

FIG. 8 illustrates a table view of a set of online chat conversations 604 associated with the POI 130 and a set of screening criteria 802 that determine a priority level 816, according to one embodiment. In one or more embodiments, the online chat conversation 102 is screened based on the set of predetermined screening criteria 802 comprising a correspondent of the POI 124, a time of the online chat conversation 806, a date of the online chat conversation 804, an attachment type associated with the online chat conversation 814, a duration of the online chat conversation 808, a waveform associated with the online chat conversation 810, and/or a keyword contained in a transcription of the online chat conversation 812. The priority level 816 of the chat conversation may be generated based on the set of predetermined screening criteria 802, and the set of the online chat conversations 604 may be organized based on the priority level 816 of the chat conversations.

In another embodiment, the predetermined screening criteria 802 may screen the online chat conversations 102 that contain important keywords 812. For example, the screening module 170 may label as “IMPORTANT” all chat conversations 102 that contain the word “MURDER.” In one or more embodiments, the analyst 110 may specify any number of predetermined screening criteria 802.

In one or more embodiments, the screening module 170 may also organize a set of the online chat conversations 604 based on importance and priority. In one or more embodiments, the screening module may generate the priority level 816 based on the predetermined screening criteria 802. In one or more embodiments, the priority level 816 may be computed based on a set of weights given to various criteria. For example, the system may set a rule that when the keyword MURDER, as above, appears in the chat conversation 102, that particular online chat conversation 102 may automatically be given a HIGH priority level. In one or more embodiments, the priority level 816 may be a number, and may be computed by the system based on values inputted by the analyst to compute the priority level.

Although the present embodiments have been described with reference to specific example embodiments, it will be evident that various modifications and changes may be made to these embodiments without departing from the broader spirit and scope of the various embodiments. Accordingly, the specification and drawings are to be regarded in an illustrative in rather than a restrictive sense.

What is claimed is:

1. A method comprising:
collecting, at a system server, and processing at a service platform, a content data associated with an online chat conversation between a person of interest (POI) and a correspondent of the POI; and
replaying the content data through a combination of a client application emulator and a proxy server to generate a realistic representation of the content data.

2. The method of claim 1 further comprising:
identifying a client application based on a metadata associated with the online chat conversation;
selecting the client application emulator from a set of client application emulators to correspond to the client application;
selecting the proxy server from a set of proxy servers to correspond to the client application emulator.

3. The method of claim 1 further comprising:
operating the combination of a client application emulator and a proxy server on at least one of a virtual machine and a physical machine; and
capturing the realistic representation of the content data by recording from at least one of a sound driver and a video driver on at least one of the virtual machine and the physical machine.

4. The method of claim 1 further comprising:
presenting the realistic representation of the content data at a workstation associated with an analyst; and
storing the realistic representation of the content data in a data store associated with the system server.

5. The method of claim 1 further comprising:
replicating the content data in real-time such that the realistic representation of the content data is generated contemporaneously with the online chat conversation;
scheduling the replication of the content data in real-time, through a queue server associated with the media-processing module of the service platform; and
streaming the realistic representation of the content data to a workstation associated with an analyst.

6. The method of claim 1 further comprising:
screening the online chat conversation based on a set of predetermined screening criteria, wherein the set of predetermined screening criteria is at least one of a chat meta data attributes including but not limited to the following: correspondent of the POI, a time of the online chat conversation, a date of the online chat conversation, an attachment type associated with the online chat conversation, a duration of the online chat conversation, a waveform associated with the online chat conversation, and a keyword contained in a transcription of the online chat conversation;
generating a priority level of the chat conversation based on a set of predetermined screening criteria; and
organizing a set of the online chat conversations based on the priority level of the chat conversations.

7. The method of claim 6 further comprising:
organizing the set of the online chat conversations based on the set of predetermined screening criteria; and
generating a special alert when the priority level of the chat conversation is greater than a predetermined threshold level.

8. The method of claim 1 further comprising:
duplicating, in real-time and transmitting, to a workstation, at least one of a voice attachment, a data attachment and a video attachment when at least one of the voice attachment, the data attachment and the video attachment is transmitted through the online chat conversation between the POI and the correspondent of the POI.

9. A method comprising:
capturing an online chat conversation between a person of interest (POI) and a correspondent of the POI;
simultaneously storing a content data comprising information related to the online chat conversation in a data store;
replicating the content data on a client application emulator communicatively coupled with a proxy server that emulates a server through which the online chat conversation is established;
capturing a realistic representation of the content data; and
storing the realistic representation of the content data in a data store.

10. The method of claim 9 further comprising:
identifying a client application based on a metadata associated with the online chat conversation;
selecting the client application emulator from a set of client application emulators to correspond to the client application; and
selecting the proxy server from a set of proxy servers to correspond to the client application emulator.

11. The method of claim 9 further comprising:
operating the client application emulator and the proxy server on at least one of a virtual machine and a physical machine; and
capturing the realistic representation of the content data by recording from at least one of a sound driver and a video driver on at least one of the virtual machine and the physical machine.

12. The method of claim 9 further comprising:
presenting the realistic representation of the content data at a workstation associated with an analyst; and
storing the realistic representation of the content data in a data store associated with the system server.

13. The method of claim 9 further comprising:
replicating the content data in real-time such that the realistic representation of the content data is generated contemporaneously with the online chat conversation;
scheduling the replicating of the content data in real-time through a queue server associated with the media processing module of the service platform; and
streaming the realistic representation of the content data to a workstation associated with an analyst.

14. The method of claim 9 further comprising:
creating a transcript of the online chat conversation;
automatically creating a folder associated with the POI and any associate of the POI; and
organizing a set of online chat conversations associated with the POI and any associate of the POI through at least one of a time of the online chat conversation, a priority level of the online chat conversation, a key word in the transcript of the online chat conversation.

15. The method of claim 9 further comprising:
creating a transcript of the online chat conversation;
determining the language of the online chat conversation is a foreign language; and
automatically translating the foreign language to another language after consulting a translation database.

16. A system comprising a processor communicatively coupled with a volatile memory and a non-volatile storage further comprising:
a media processing module including:
a proxy server to emulate a server associated with a client application,
a client application emulator to generate at least one of an audible and a viewable version of an online chat conversation, and
a media capture module to capture at least one of an audible and a viewable version of the online chat conversation; and
a storage module communicatively coupled to the media processing module to store at least one of an audible and a viewable version of the online chat conversation.

17. The system of claim 16 further comprising:
a system server:
to collect a set of communication and transaction data from a network being used by the POI,
to process the set of communication and transaction data,
to extract a metadata and a content data from the set of communication and transaction data, and
to store the metadata and the content data.

18. The system of claim 17 further comprising:
a communication channel, to automatically transmit the metadata and the content data between modules of the service platform and the system server.

19. The system of claim 16 further comprising:
a service platform:
to receive and store the metadata and the content data, to transmit the metadata and the content data to the media processing module and
to receive at least one of the audible and the viewable version of the content data from the media processing module.

20. The system of claim 16 further comprising:
a screening module:
to screen the online chat conversation for a set of predetermined screening criteria,
to organize the set of the online chat conversations based on the set of predetermined screening criteria,
to generate a priority level of the online chat conversation based on the set of predetermined criteria, and
to generate a special alert when the priority level of the online chat conversation is greater than a predetermined threshold level.
